(19) United States
(12) Patent Application Publication
(10) Pub. No.: US 2003/0112794 A1
(43) Pub. Date: Jun. 19, 2003

(54) System and method for multiple PDP contexts with a single PDP address at a GGSN

(76) Inventor: Bollapragada Manohar, Munich (DE)

Correspondence Address: Siemens Corporation, Attn: Elsa Keller, Legal Administrator, Intellectual Property Department, 186 Wood Avenue South, Iselin, NJ, 08830, US

(21) Appl. No.: 10/027,623

(22) Filed: Dec. 19, 2001

(51) Int. Cl. H04L 12/66

(52) U.S. Cl. 370/352; 370/329

(57) ABSTRACT

A General Packet Radio Service (GPRS) system includes a mapping module (218) at an SGSN (Serving GPRS Support Node) and a port assignment module (220) at a GGSN (Gateway GPRS Support Node). The port assignment module (220) can assign each IP address to a plurality of I/O ports (such as TCP ports). The mapping module (218) maintains a mapping between IP address and I/O port for a given connection. In operation, all available TCP ports are assigned a given IP address until the ports available are exhausted. A new IP address is then assigned to the same ports.

### BACKGROUND OF THE INVENTION

The present invention relates to telecommunication systems and, particularly, to a system for implementing multiple PDP contexts with a single PDP address in a Gateway GPRS Support Node (GGSN) of a General Packet Radio Service (GPRS).

The General Packet Radio Service is a data service for GSM (Global System for Mobile Communication) networks. GPRS is a packet-based technology that allows an end-user to remain constantly connected and to send and receive data at speeds higher than those available for prior circuit-switched technologies.

A simplified diagram of a basic GPRS system is shown in FIG. 1. The system 100 includes a mobile station 102, which may be, for example, a notebook computer with a GPRS-capable PC card. The mobile station 102 communicates with a Base Station System (BSS) 104, i.e, GSM Base Station System or UMTS Terrestrial Radio Access Network (UTRAN). The base station system 104 sends and receives GPRS packets to and from the GPRS network 106. In particular, the base station system 104 sends and receives the GPRS packets to and from a Serving GPRS Support Node (SGSN) 108. The SGSN 108 monitors the mobile stations within its service area and interfaces to the mobile stations 102. The SGSN 108 communicates with a Gateway GPRS Support Node (GGSN) 110 via a protocol called the GPRS tunnel protocol (GTP). The GGSN 110 interfaces to packet data networks (PDN) 112, such as Internet or X.25 networks. When the mobile station 102 sends data, the packets are sent via the SGSN 108 to the GGSN 110, which converts them into the desired format. Packets from the PDN 112 are received at the GGSN 110, then forwarded to the mobile station 102 via the SGSN 108. A Home Location Register (HLR) 114 stores various subscription information.

In a particular system implementable using the GPRS system of FIG. 1, for any packet transfer between a computer in an IP network and a mobile station, a PDP context must be activated. As part of the PDP context activation, the GGSN will assign an IP address to the mobile station. When the mobile station has an IP address, it can communicate with the IP network and a computer in the IP network can communicate with the mobile station.

However, the total number of IP addresses available to the GGSN is finite and, as such, limits the number of mobile stations able to access the IP network at the same time. Further, while certain systems implement dynamic IP addressing at the GGSN, such systems typically use the Dynamic Host Configuration Protocol (DHCP). This can require an undesirably high level of overhead at the GGSN.

### SUMMARY OF THE INVENTION

These and other problems in the prior art are overcome in large part by a system and method according to embodiments of the present invention. A General Packet Radio Service (GPRS) system according to an embodiment of the present invention includes a mapping module at an SGSN (Serving GPRS Support Node) and a port assignment module at a GGSN (Gateway GPRS Support Node). The port assignment module can assign each IP address to a plurality of I/O ports (such as TCP ports). The mapping module maintains a mapping between IP address and I/O port for a given connection. In operation, all available TCP ports are assigned a given IP address until the ports available are exhausted. A new IP address is then assigned to the same ports.

A telecommunications system according to an embodiment of the present invention includes a packet network, such as an Internet Protocol (IP) network and a General Packet Radio Service (GPRS) network. Mobile stations in the GPRS network are able to communicate with computers and other devices attached to the packet network. The GPRS network includes a Gateway GPRS Support Node (GGSN) and a Serving GPRS Support Node (SGSN). IP addresses can be assigned to a plurality of ports on the GGSN. The SGSN maintains a mapping between the IP address and port for a given connection.

A GPRS telecommunications system according to an embodiment of the present invention includes a Serving GPRS support node (SGSN) including a mapping module and adapted to interface to a mobile station; and a gateway GPRS support node (GGSN) including a port assignment module and adapted to couple to a packet network. The port assignment module is adapted to sequentially assign a plurality of IP addresses to same TCP ports and the mapping module is adapted to maintain a mapping between a particular port, an IP address, and a mobile station during a connection between the mobile station and the packet network

A better understanding of these and other embodiments of the invention is obtained when the following detailed description is considered in conjunction with the following drawings.

### BRIEF DESCRIPTION OF THE DRAWINGS

FIG. 1 is a simplified diagram illustrating a GPRS network system;

FIG. 2 is a diagram illustrating a GPRS network according to an implementation of the invention;

FIG. 3A is a diagram schematically illustrating operation of an embodiment of the present invention;

FIG. 3B is a diagram illustrating SGSN mapping according to an embodiment of the present invention;

FIG. 4 is a signaling diagram illustrating operation of an embodiment of the present invention;

FIG. 5 is a signaling diagram illustrating operation of an embodiment of the present invention.

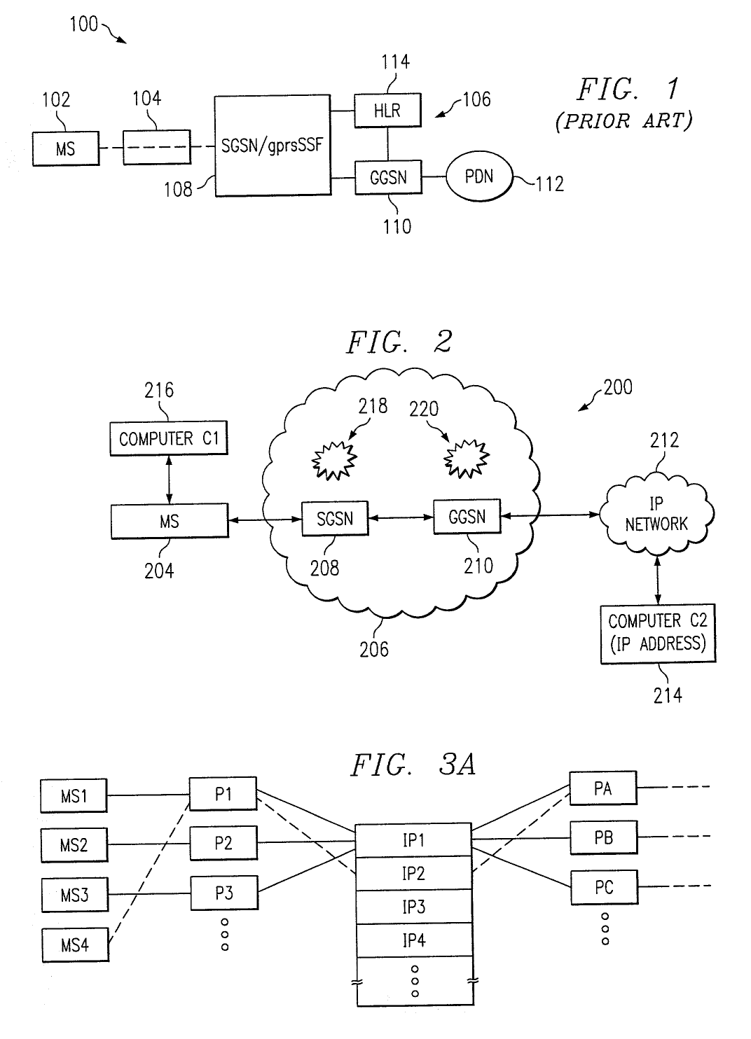

### DETAILED DESCRIPTION OF EMBODIMENTS OF THE INVENTION

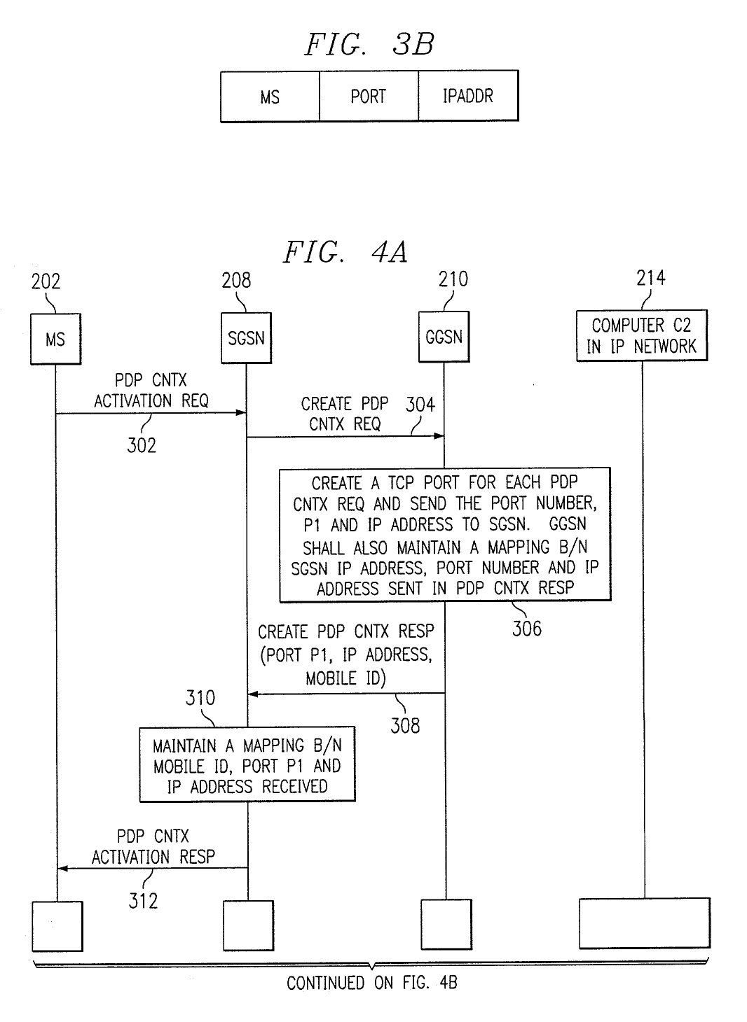

A diagram of an exemplary GPRS system according to an implementation of the invention is shown in FIG. 2. The system 200 includes a mobile station 204, which may be, for example, a mobile telephone or a notebook computer 216 with a GPRS-capable PC card. The mobile station 204 sends and receives GPRS packets to and from the GPRS network 206, typically via a base station (not shown). In particular, the mobile station sends and receives the GPRS packets to and from a Serving GPRS Support Node (SGSN) 208. The SGSN 208 monitors the mobile stations within its service area and interfaces to the mobile stations. The SGSN 208 communicates with a Gateway GPRS Support Node (GGSN) 210 via a protocol called the GPRS tunnel protocol (GTP). The GTP protocol is over UDP/IP protocols. The GGSN 210 interfaces to packet data networks (PDN) 212, such as Internet or X.25 networks. When the mobile station 204 sends data, the packets are sent via the SGSN 208 to the GGSN 210, which converts them into the desired format. Packets from the PDN 212 are received at the GGSN 210, then forwarded to the mobile station 204 via the SGSN 208.

In addition, as will be explained in greater detail below, the SGSN 208 includes a mapping module 218 and the GGSN includes a port assignment module 220 according to embodiments of the present invention. While any GPRS system capable of interfacing to a packet network may be employed, a particular system is described in co-pending U.S. patent application Ser. No. ______, concurrently filed, titled SESSION INITIATION PROTOCOL (SIP) USER AGENT IN A SERVING GPRS SUPPORT NODE (SGSN) having inventor Chenghui Wang (Attorney Docket No. 01P4874US01), which is hereby incorporated by reference in its entirety as if fully set forth herein.

In operation, the port assignment module 220 opens a TCP port and listens on the port for any connections from the mobile stations. When a PDP Context Activation Request is received, the mapping module 220 opens another TCP port and establishes a connection between the mobile station 204 and the GGSN 210. During this process, the GGSN 210 sends the port number and an IP address from an IP address pool to the SGSN 208. The mapping program 218 at the SGSN 208 maintains a mapping between the received port number, IP address, and the mobile identity, so that it can route the packet received from the GGSN 210 to the mobile. The connection from the GGSN 210 to the computer 214 using another TCP port will be established as soon as the GGSN 210 receives a request from the mobile station specifying the destination IP address. The mapping module 220 maintains a mapping between the TCP port and IP address for the mobile connection and the TCP port and IP address for the computer connection.

The mapping module 218 maintains the mapping between the received port number, received IP address and the mobile identity. The mapping is used to route the packets from the GGSN 210 to the mobile station. As will be explained in greater detail below, the SGSN 208 receives the port number and IP address in response to its Create Context Activation Request. The SGSN 208 sends the received IP address to the mobile station as the PDP Context Activation Response.

With a single IP address, the mapping and port assignment modules can support M/2 PDP contexts, where M is the number of ports available at the GGSN. Once all the TCP ports for an IP address have been exhausted, the process will be repeated with a new IP address and the same ports. Thus, a pool of N IP addresses at the GGSN can support N*M/2 PDP contexts.

It is noted that the invention is applicable to cases in which the mobile station moves from one SGSN to another. In such cases, the old SGSN informs the new SGSN and GGSN of the mapping.

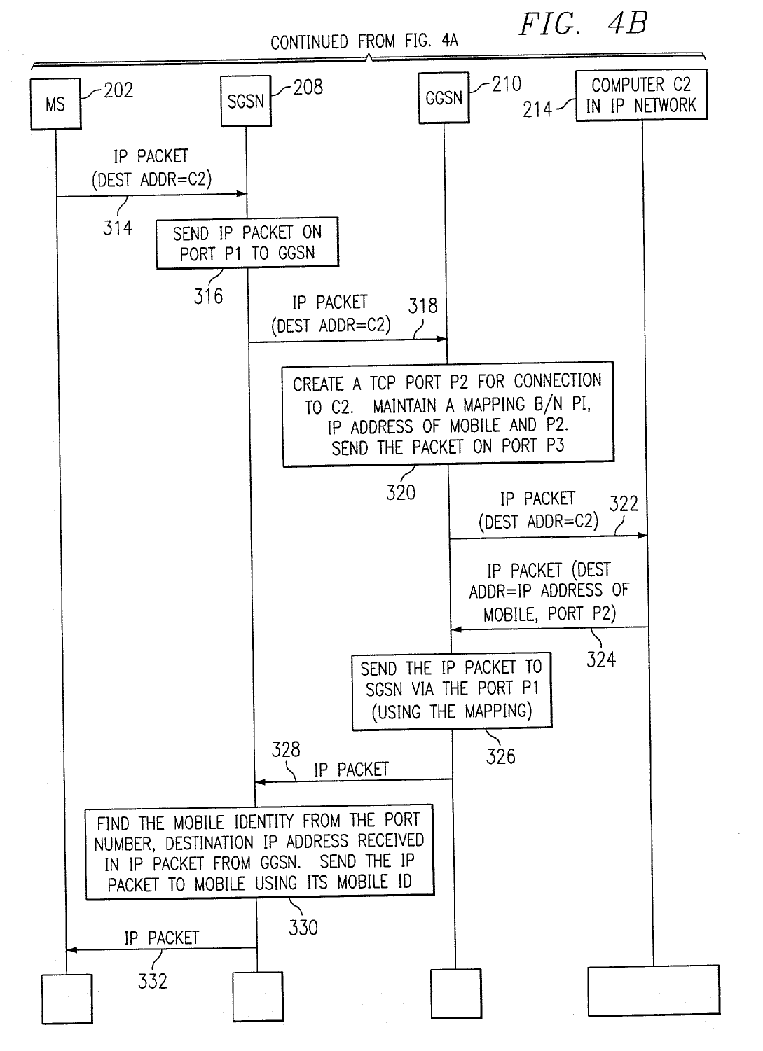

FIG. 3A is a diagram schematically illustrating the mapping in greater detail, according to a specific embodiment. Shown are a plurality of mobile stations MS1-MS4, a first plurality of ports P1-P3, a second plurality of ports PA-PC, and a plurality of IP addresses IP1-IP4. It is noted that, in practice, more than four mobile stations and more than four IP addresses and ports will be in use. Thus, the figure is exemplary only.

In operation, a mobile station, such as mobile station MS1, is assigned a port P1 on the GGSN for communicating with the mobile station, an IP address IP1, and a port PA for communicating with a computer. A mobile station MS2 may be assigned a port P2, the same IP address IP1, and a port PB. Similarly, the mobile station MS3 may be assigned port P3, IP address IP1, and port PC. As will be described in greater detail below, the communication may be initiated by either a computer on the packet network or one of the mobile stations.

When a next communication, such as using mobile station MS4 is to occur, it is assigned port P1, a next IP address, IP2, and the port PA. That is, once the available ports P1-P3 have been used with an IP address, the port is re-used with a next IP address. Subsequent mobile stations and ports are handled similarly.

To accommodate this use of more than one IP address at a given port, the SGSN 208 maintains a mapping of mobile station identification, port, and IP address. Thus, as shown in FIG. 3B, the SGSN maintains in memory a listing of the mobile station, its port, and the corresponding IP address.

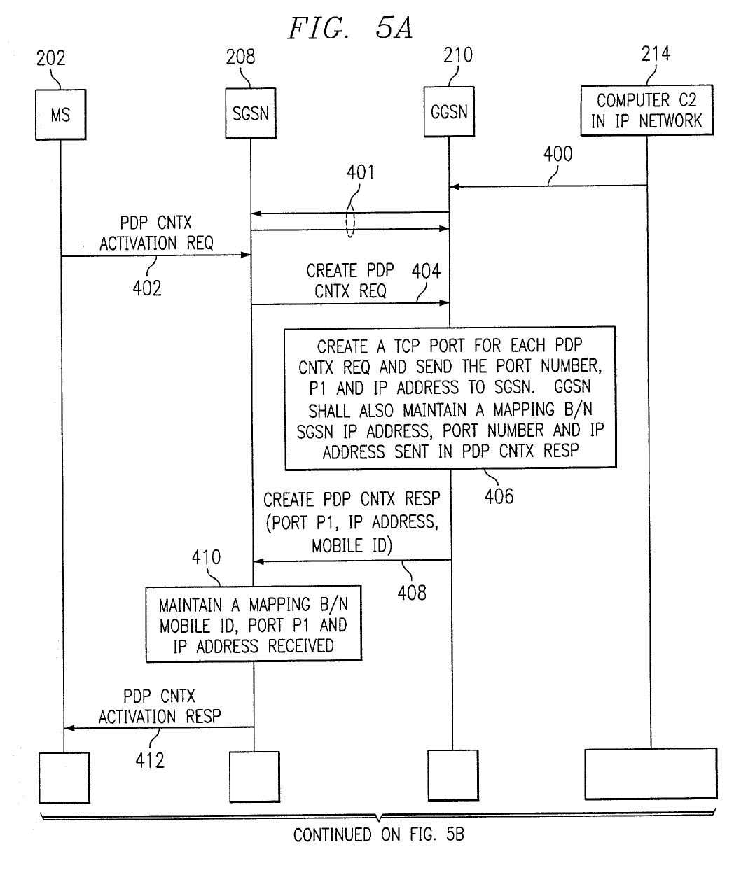

Operation of an embodiment of the invention is shown with reference to FIG. 4. In particular, FIG. 4 illustrates signaling flow for a mobile station establishing a connection to a computer in an IP network. Shown in FIG. 4 are a mobile station 202, the SGSN 208, the GGSN 210, and a computer 214 in the IP network.

Initially, in 302, the mobile station 202 sends a PDP Context Activation Request to the SGSN 208. In 304, the SGSN 208 issues a Create PDP Context Request to the GGSN 210. At 306, the GGSN 210 then creates a TCP port for each PDP Context Request and maintains a mapping between the SGSN IP address, port number, and the IP address sent back. In 308, the GGSN 210 sends a Create PDP Context Response, including the port number P1 and IP address to the SGSN 208. At 310, the SGSN 208 maintains a mapping between the mobile ID, port and the IP address received. In 312, the SGSN 208 sends a PDP Context Activation Response to the mobile station 202.

In 314, the mobile station 202 will send one or more IP packets, having a destination address of the computer 214, to the SGSN 208. In 316, the SGSN 208 sends the IP packet to the port P1 for transmission to the GGSN 210. In 318, the transmission of the IP packet to the GGSN occurs. In 320, the GGSN 210 creates a TCP port P2 for connection to the computer 214. The GGSN 210 further maintains a mapping between the port P1, the IP address of the mobile station 204, and the port P2. The packet is then routed through the port P2. In 322, the packet is transported to the computer 214. In 324, the computer 214 responds with an IP packet of its own, this time having a destination address of the mobile and identifying port P2.

At 326, the GGSN 210 accesses the mapping to determine the port which is to be used for transmitting to the SGSN 208. In 328, the packet is sent to the SGSN 208 on the port P1. At 330, the SGSN 208 determines the mobile station 202's identity from the port number and destination IP address received in the IP packet. Finally, at 332, the IP packet is sent to the mobile station using the mobile ID.

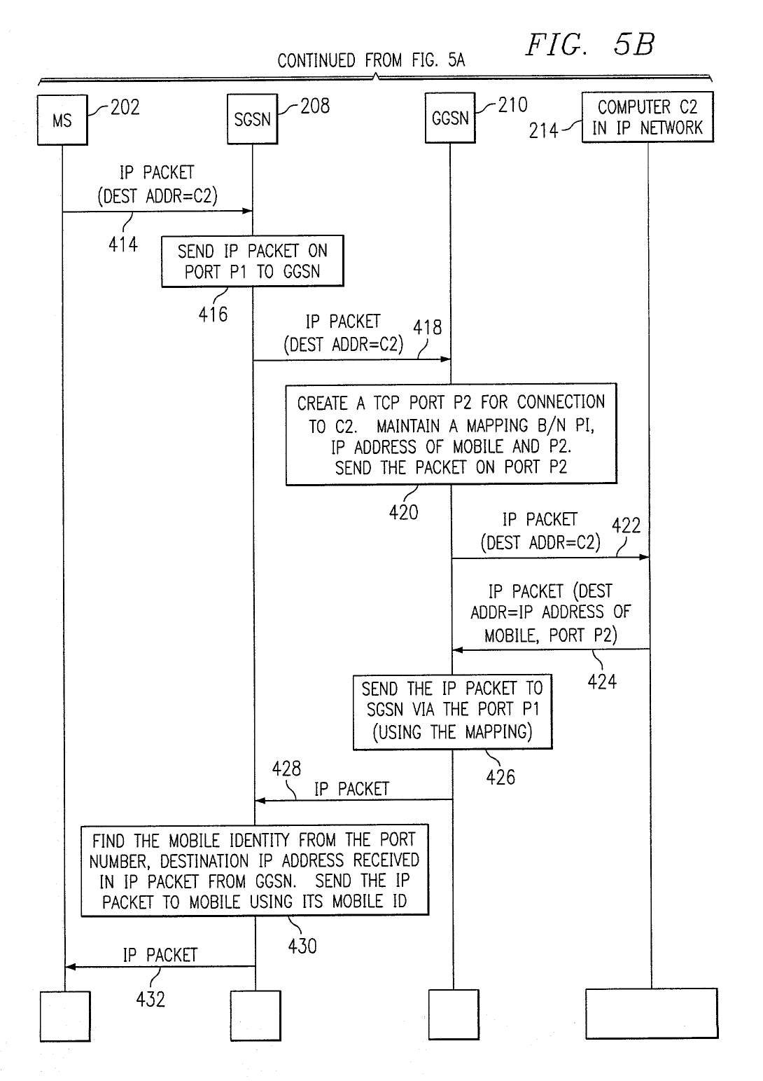

Operation of an embodiment of the invention is shown with reference to FIG. 5. In particular, FIG. 5 illustrates signaling flow for a computer in an IP network establishing a connection to a mobile station. Shown in FIG. 5 are a mobile station 202, the SGSN 208, the GGSN 210, and a computer 214 in the IP network.

Initially, the computer 214 makes a Connection Request to the Mobile Station at 400, which is transmitted to the GGSN 210. At 401a, the GGSN 210 then makes a PDU Notification Request to the SGSN 208. The SGSN 208 responds at 401b with a PDU Notification Response. In 401c, the SGSN 208 issues a Request PDP Context Activation to the mobile station 204.

In 402, the mobile station 202 responds with a PDP Context Activation Request sent to the SGSN 208. In 404, the SGSN 208 issues a Create PDP Context Request to the GGSN 210. In 406, the GGSN 210 then creates a TCP port for each PDP Context Request and maintains a mapping between the SGSN IP address, port number, and the IP address sent back. In 408, the GGSN 210 sends a Create PDP Context Response, including the port number and IP address to the SGSN 208. At 410, the SGSN 208 maintains a mapping between the mobile ID, port and the IP address received. In 412, the SGSN 208 sends a PDP Context Activation Response to the mobile station 204.

In 414, the mobile station 202 will send one or more IP packets, having a destination address of the computer 214, to the SGSN 208. In 416, the SGSN 208 sends the IP packet to the port P1 for transmission to the GGSN 210. In 418, the transmission of the IP packet to the GGSN occurs. In 420, the GGSN 210 creates a TCP port P2 for connection to the computer 214. The GGSN 210 further maintains a mapping between the port P1, the IP address of the mobile station 204, and the port P2. The packet is then routed to the port P2. In 422, the packet is transported to the computer 214. In 424, the computer 214 responds with an IP packet of its own, this time having a destination address of the mobile and identifying port P2.

At 426, the GGSN 210 accesses the mapping to determine the port which is to be used for transmitting to the SGSN 208. In 428, the packet is sent to the SGSN 208 on the port P1. At 430, the SGSN 208 determines the mobile station 202's identity from the port number and destination IP address received in the IP packet. Finally, at 432, the IP packet is sent to the mobile station using the mobile ID.

The invention described in the above detailed description is not intended to be limited to the specific form set forth herein, but is intended to cover such alternatives, modifications and equivalents as can reasonably be included within the spirit and scope of the appended claims.

What is claimed is:

1. A GPRS telecommunications system, comprising:
a Serving GPRS support node (SGSN) including a mapping module and adapted to interface to a mobile station; and
a gateway GPRS support node (GGSN) including a port assignment module and adapted to couple to a packet network;
wherein said port assignment module is adapted to sequentially assign a plurality of IP addresses to same TCP ports and said mapping module is adapted to maintain a mapping between a particular port, an IP address, and a mobile station during a connection between said mobile station and said packet network.

2. A telecommunications system in accordance with claim 1, wherein said IP addresses are assigned to said ports responsive to a PDP activation request.

3. A telecommunications system in accordance with claim 2, wherein said SGSN receives a port identification and an IP address responsive to a Create PDP context request.

4. A telecommunications system in accordance with claim 3, wherein said SGSN sends the received IP address to a mobile station in a PDP Context Activation Response.

5. A GPRS telecommunications system, comprising:
a Serving GPRS support node (SGSN) adapted to interface to a plurality of mobile stations;
a gateway GPRS support node (GGSN) adapted to couple to a packet network; and
means for assigning an IP address to a plurality of TCP ports such that a plurality of said mobile stations can simultaneously communicate with said packet network using said IP address over different ones of said TCP ports.

6. A GPRS telecommunications system in accordance with claim 5, said assigning means comprising means for assigning said IP addresses to said ports responsive to a PDP activation request.

7. A GPRS telecommunications system in accordance with claim 6, wherein said SGSN receives a port identification and an IP address responsive to a Create PDP context request.

8. A GPRS telecommunications system in accordance with claim 7, wherein said SGSN sends the received IP address to a mobile station in a PDP Context Activation Response.

9. A telecommunications method, comprising:
assigning multiple IP addresses to a same port in a GGSN; and
transmitting packets from multiple mobile stations via said port.

10. A telecommunications method in accordance with claim 9, said assigning comprising assigning said IP addresses to said ports responsive to a PDP activation request.

11. A method in accordance with claim 10, further comprising: a SGSN receiving a port identification and an IP address responsive to a Create PDP context request.

12. A method in accordance with claim 11, further comprising said SGSN sending the received IP address to a mobile station in a PDP Context Activation Response

13. A method, comprising:
providing a Serving GPRS support node (SGSN) including a mapping module and adapted to interface to a mobile station; and
providing a gateway GPRS support node (GGSN) including a port assignment module and adapted to couple to a packet network;
wherein said port assignment module is adapted to sequentially assign a plurality of IP addresses to same TCP ports and said mapping module is adapted to maintain a mapping between a particular port, an IP address, and a mobile station during a connection between said mobile station and said packet network.

14. A method in accordance with claim 13, wherein said IP addresses are assigned to said ports responsive to a PDP activation request.

15. A method in accordance with claim 14, wherein said SGSN receives a port identification and an IP address responsive to a Create PDP context request.

16. A method in accordance with claim 15, wherein said SGSN sends the received IP address to a mobile station in a PDP Context Activation Response.
